(19) United States
(12) Patent Application Publication
(10) Pub. No.: US 2017/0206551 A1
(43) Pub. Date: Jul. 20, 2017

(54) Personalized Recommendation Computation in Real Time using Incremental Matrix Factorization and User Factor Clustering

(71) Applicant: Adobe Systems Incorporated, San Jose, CA (US)

(72) Inventors: Piyush Gupta, Noida (IN); Nikaash Puri, New Delhi (IN); Mohit Srivastava, Noida (IN); Mandapaka Venkat Jagannath Rao, New Delhi (IN)

(21) Appl. No.: 14/996,806

(22) Filed: Jan. 15, 2016

(51) Int. Cl. G06Q 30/02; G06F 3/0484; G06N 99/00; G06F 17/30

(52) U.S. Cl. CPC G06Q 30/0254; G06F 17/30598; G06F 3/0484; G06N 99/005

(57) ABSTRACT

Recommendation control techniques using incremental matrix factorization and clustering are described. User latent factors and item latent factors are computed from data that denotes ratings associated with the users regarding respective ones of the plurality of items of digital content. Data is obtained that describes interaction of a particular one of the users with at least one respective item of the digital content. A plurality of clusters is formed using the user latent factors. The recommendations are generated using the user latent factors and the item latent factors for each of the plurality of clusters. Further, at least one of recommendations is located based on comparison of a user identifier of a subsequent user with the plurality of clusters. Interaction of the subsequent user with the digital content is controlled based on the located at least one of the recommendations.

### BACKGROUND

Digital content recommendation techniques are used in digital medium environments to recommend digital content based on user interaction. For example, a service provider of a web site may employ a model generated from training data that describes interactions of users with respective items, e.g., users' interaction with particular webpages, advertisements, and other digital content. This model is then used to recommend digital content to a subsequent user to increase a likelihood that the subsequent user will select other digital content or even purchase a good or service made available by the service provider.

The model, for instance, may use information indicating that users having a particular brand of phone desire a particular item, e.g., a memory card. Based on this, a recommendation is made to control which digital content is provided to users having that brand of phone, e.g., an advertisement of the memory card that is selectable to initiate a purchase of the memory card. In this way, the recommendations may be used to increase a likelihood that a user will find an item of interest from the service provider and thus benefit both the user and the service provider.

However, conventional digital content recommendation techniques are resource and computationally expensive. As such, these conventional techniques are not performable in real time or involve compromises that may have an effect on the accuracy of the recommendations and thus decrease a likelihood of the recommendations being of interest to the users.

One conventional technique that is employed to generate recommendations is referred to as matrix factorization. Matrix factorization is a technique that involves factorizing one matrix into two matrices. This is useful to make recommendations, such as to factorize a matrix describing ratings of a user for individual items (e.g., goods or services) into a user latent matrix and an item latent matrix that are then usable as models to make recommendations. However, this technique is not generally performable in real time due to computation and storage requirements and consequently is run at predefined intervals, e.g., every 24 hours. By real-time, it is meant that the computation carried out to generate a response to a request for a recommendation does not significantly impact response latency, e.g., to form a response within one hundred milliseconds.

There are a variety of conventional approaches that are employed to address these challenges in an attempt to achieve real time generation of recommendations, but these approaches are not successful. The first approach involves storing precomputed recommendations for each user that visits a website, which is computationally simple. However, the storage costs associated with this approach are significant. For instance, a website may encounter traffic involving millions of users, e.g., seventy million users are not uncommon. Storing and computing recommendations for each of these users may be considered wasteful since it has been observed that more than ninety percent of these users will not return to the website in a single day.

For example, in order to support seventy million users with one thousand recommended items per user results in 560 GB of storage for a single recommendation algorithm. If an assumption is made that there are three recommendations and two algorithms per recommendation for A versus B testing, this results in storage of 3.36 TB of recommendation data. Additionally, use of compression to reduce this storage requirement involves a tradeoff between the compression performance achieved and the associated coding and decoding speeds and thus introduces additional challenges when included to reduce this amount of data that is stored.

In a second approach, user and item latent factors that are used to compute the recommendations are stored, solely, rather than computing and storing the pre-configured recommendations as performed in the approach above. Then, when a user interacts with the website, the conventional technique is used to compute the recommendations using the user and item latent factors and sorts the recommendations based on a predicted rating to determine which of the recommendations are to be provided to a particular user. In this approach, although efficient storage is achieved, generation of the recommendations is computationally expensive and hence cannot be performed in real time, e.g., such as to address seventy million users and 1.5 million items that are available for interaction with that user. Accordingly, these conventional approaches cannot support real time generation of recommendations and therefore cannot react dynamically to a user's interaction as it occurs.

Because of these computational and storage requirements, conventional recommendation techniques are typically performed at predefined intervals as described above. This is performed by re-computing an entirety of the user and item latent factor matrices for each of the users and items being described. As a significant number of users and items may be described in these matrices (e.g., seven million users and 1.5 million items), this computation cannot address a user's current interaction with items and thus lacks accuracy of a real time recommendation.

### SUMMARY

Recommendation control techniques using incremental matrix factorization and clustering are described. In one or more embodiments, user latent factors and item latent factors are computed from data that denotes ratings associated with the users regarding respective ones of the plurality of items of digital content. For example, the user latent factors may be defined using a user latent factor matrix, the item latent factors defined using an item latent factor matrix, and the data that denotes ratings associated with the users regarding respective ones of the plurality of items defined by a user-item matrix. The user latent factor matrix and the item latent factor matrix are calculated using a matrix factorization technique from the user-item matrix, such as an alternating least squares technique. This technique involves a number of iterations. In each of which one of the user latent factor matrix or the item latent factor matrix is kept fixed alternately while the other one is recomputed until convergence.

Data is obtained that describes interaction of a particular one of the users with at least one respective item of the digital content. In one example, this data describes a user's current interaction with a website or other digital content of a service provider. The user latent factor is updated that corresponds to the particular one of the users using the obtained data, and not for an entirety of the user latent factor matrix and in this way supports real time performance in the calculation of recommendations.

A plurality of clusters is formed using the user latent factors, such as to group users of the user latent factor matrix based on similarity, one to another. A variety of clustering techniques may be used, such as a K-means clustering techniques. The recommendations are generated using the user latent factors and the item latent factors for each of the plurality of clusters using the cluster centroids. In this way, the number of recommendations that are precomputed and stored may be reduced, thus improving computational and storage efficiency. Further, at least one of recommendations is located based on comparison of a user identifier of a subsequent user with the plurality of clusters. This is done by first determining the cluster to which this user belongs. This is followed by retrieving the precomputed recommendations for that cluster. Finally, the user factor is used to reorder the cluster recommendations and obtain personalized recommendations. Interaction of the subsequent user with the digital content is controlled based on the located at least one of the recommendations, such as to determine which items of digital content are most likely to result in interaction or conversion by the subsequent user, and thus is beneficial to both the subsequent user as well as the service provider.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in accordance with an example embodiment that is operable to employ recommendation control using incremental matrix factorization and clustering techniques described herein.

FIG. 2 depicts an example embodiment showing a recommendation control system of FIG. 1 in greater detail.

FIG. 3 depicts an example embodiment in which central servers of the recommendation control system of FIG. 2 are used to compute recommendations.

FIG. 4 depicts an example embodiment in which recommendations formed by the central servers in FIG. 3 are employed at runtime by one or more edge servers to select recommendations to control digital content interaction with a user.

FIG. 5 depicts a table showing a Root Mean Squared Error (RMSE) of incremental updates versus without an update after training with percentage of data used for training.

FIG. 6 depicts the data in table of FIG. 5 graphically.

FIG. 7 depicts a table in accordance with an example embodiment that shows an example of results that illustrate a possibility of getting correct results for top-50 recommendations by storing additional recommendations per cluster.

FIG. 8 is a flow diagram depicting a procedure in an example embodiment in which incremental matrix factorization and clustering techniques are described.

FIG. 9 illustrates an example system including various components of an example device that can be implemented as any type of computing device as described or utilize with reference to FIGS. 1-8 to implement embodiments of the techniques described herein.

### DETAILED DESCRIPTION

### Overview

Recommendations in a digital medium environment are used to control user interaction with digital content, such as to increase the likelihood of a user to select an advertisement or purchase a good or service from a service provider. For example, the recommendations are generated based on increased understanding of a user in order to control recommendation of items that accurately meet a user's requirements, tastes, or preferences and in this way help the user locate desired items as part of an enriched user experience. Accordingly, recommendations may be used to indicate which items of digital content (e.g., advertisements, webpages, and so forth) are to be provided to the users and as such accuracy of the recommendations has a direct relation to a likelihood that the user receives digital content of interest.

In order to increase the likelihood that the recommendation is accurate, recommendations may be generated in real time to address a user's current interaction with digital content. For example, a user may navigate through a website through selection of webpages and advertisements within webpages. Thus, this interaction may be used to determine the user's current interests and thus recommendations that address this interaction have an increased likelihood of being accurate and thus resulting in conversion of a good or service.

Accordingly, recommendation modelling and computation techniques are described in the following that employ incremental matrix factorization and clustering, which may be used to support real time generation of recommendations while addressing the challenges of storage and computational resource consumption of conventional techniques. These techniques are usable to support real time output of recommendations that also include the latest interaction of the user with digital content in the model, e.g., as a user navigates through webpages of a website, selects advertisements, and so forth.

In one example, matrix factorization is used, such as through use of an alternating least squares technique, to generate a user latent matrix and an item latent matrix as models that are usable to make recommendations. The user latent matrix and item latent matrix represent knowledge that is not directly observable using latent factors of the users and latent factors of items, referred to as user latent factors and item latent factors in the following. These matrices are formed through factorization of a matrix that describes user and item interactions. From this, the user latent factors may be used to match item latent factors such that features associated with a user match features associated with an item in order to make recommendations that are not directly observable from the matrix describing user interaction with items, i.e., why the user chose to perform the interaction is not directly observable but may be inferred using this technique.

In order to include the recent user interactions in the model to support real time usage, a user latent factor is recomputed that is specific to the user whose interaction with an item is to be factored in as part of making the recommendation rather than re-compute an entirety of a user latent factor matrix for each of the users represented in the matrix. In this way, the update of the latent factor for a single user is not computationally expensive and thus can be done in real-time, e.g., does not significantly contribute to latency in providing digital content to the user based on the recommendations.

Additionally, techniques are described in the following to balance storage and computation requirements (e.g., at runtime) without a significant impact on the quality of the recommendations. In this example, clustering techniques are used to find recommendations for “K” representative user latent factors, e.g., through use of K-means clustering on the “U” user latent factors. The number of clusters may be chosen based on a number of different types of users to be represented, may be chosen automatically based on clustering performed based on a threshold levels of similarity of the users, one to another, and so forth. This is used to conserve storage and pre-computation resources because recommendations are not computed and stored for each of the users. Further, by precomputing a number of recommendations for a cluster-centroid that is larger than that are returned for each user, it is possible to find the “right set” of recommendations for the users that are associated with the cluster. For instance if five recommendations are to be delivered for each user, in some embodiments, good results can be delivered by pre-computing and storing twenty-five recommendations per cluster centroid. These recommendations are then re-ordered for a particular user to generate the top five recommendations for that user as further described below.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

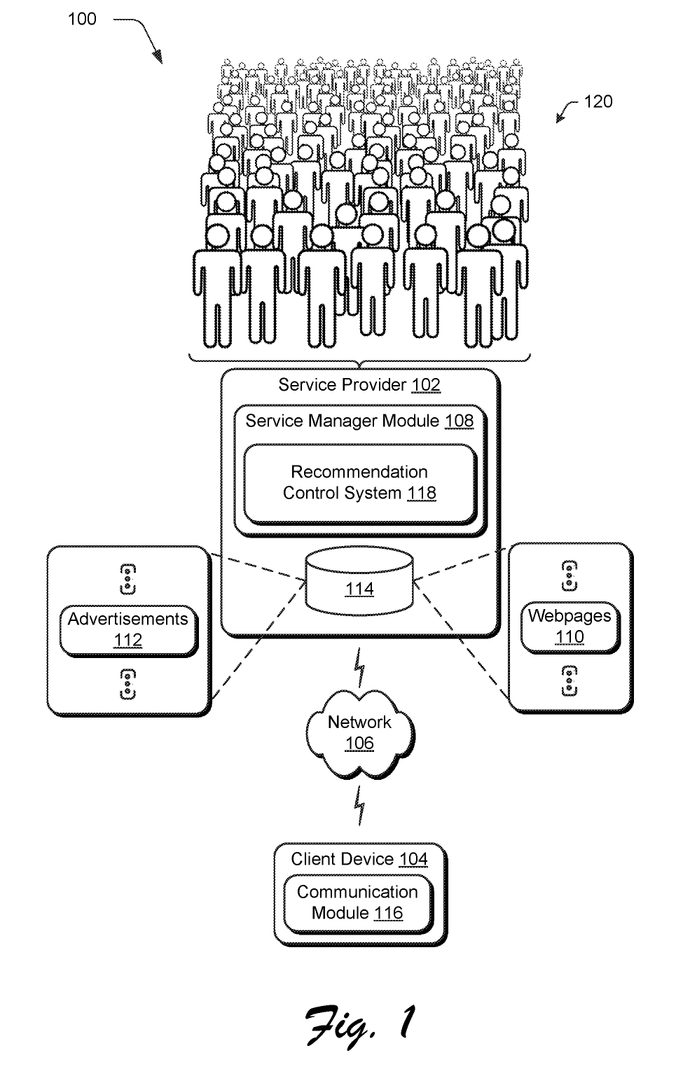

FIG. 1 is an illustration of an environment 100 in an example embodiment that is operable to techniques described herein. The illustrated environment 100 includes a service provider 102 and a client device 104 that are communicatively coupled, one to another, via a network 106, which may be configured in a variety of ways.

The service provider 102 and client device 104 may be implemented by one or more computing devices. A computing device, for instance, may be configured as a desktop computer, a laptop computer, a mobile device (e.g., assuming a handheld configuration such as a tablet or mobile phone as illustrated), and so forth. Thus, a computing device may range from full resource devices with substantial memory and processor resources (e.g., personal computers, game consoles) to a low-resource device with limited memory or processing resources (e.g., mobile devices). Additionally, a computing device may be representative of a plurality of different devices, such as multiple servers utilized by a business to perform operations “over the cloud” as further described in relation to FIG. 9.

The service provider 102 is illustrated as including a service manager module 108 that is representative of functionality to control user interaction with digital content. Examples of digital content are illustrated as webpages 110 and advertisements 112 that are stored in storage 114 and made available to the client device 104 via the network 106, such as through a communication module 116 including a browser, network-enabled application, and so forth. The service manager module 108, for instance, may determine which webpages 110 or advertisements 112 to provide to the client device 104 to increase a likelihood that the user will find this digital content of interest. This interest may then result in a corresponding increase in likelihood that the user will select the digital content resulting in a conversion such that the user purchases a good or service, and so on.

As part of this control, the service management module 108 includes a recommendation control system 118 that is representative of functionality to recommend items of digital content for interaction with particular users 120, e.g., particular ones of the advertisements 112 when included in a webpage 110. In this way, the service manager module 108 may determine which of the plurality of items of digital content will most likely result in a conversion for a particular user and provide those items.

A variety of techniques may be utilized by the recommendation control system 118 to form recommendations. For example, collaborative filtering (CF) is a type of recommendation technique that seeks to exploit users' interactions and explicit item ratings in order to predict the propensity of a user to consume an item, e.g., to buy a product, view video content, listen to audio data, and other digital content, even for an unseen item. Memory-based collaborative filtering and neighborhood search techniques also exploit item-to-item similarity or user-to-user similarity.

For example, a determination may be made that users are similar, and then recommendations are made to a user based on what similar users have liked. For instance, a user may like a particular brand of phone based on interaction with a website. Based on the interaction, which may include previous interactions by the user, collaborative filtering techniques may be used to first deduce that other users who liked that particular brand of phone often end up purchasing another phone having that brand. As a result, the website may recommend that purchase through digital content relating to that brand, e.g., a targeted advertisement, thereby predicting the user's desires and driving sales at the service provider 102.

Collaborative filter techniques are also useful in determining item-to-item similarity measures in which other related items to that particular brand of phone are recommended based on user interactions. For instance, it may also be determined that users desiring that particular brand of phone often purchase memory cards. Accordingly, for a new user looking at that brand of phone, a recommendation may be made regarding the memory cards, which also predict the user's desires to drive sales and is thus beneficial to both the user and the service provider 102.

Another collaborative filtering technique is based on latent factors models. These can be generative probabilistic models like latent dirichlet allocation (LDA), probabilistic latent semantic analysis (PLSI), and so on which are typically used to find hidden topics that explain occurrences of words in documents. A variation of a latent factor model is matrix factorization where a sparse user/item matrix is factorized to find user latent factors and item latent factors. Since the predictions made using matrix factorization are accurate and useful practically, matrix factorization may be utilized by the recommendation control system 118 to make the recommendation or included in the set of recommendation techniques where a final recommendation is based on a combination of output of several techniques.

In a latent factor matrix factorization model, the rows of a user-item matrix “P” are the users and the columns of this matrix are the items. For example, if there are “n” users and “m” items this matrix is of order “n×m.” A particular element “P(i,j)” in this matrix denotes the rating given by user “U(i)” on item “I(j).” If the user has not seen the item or not rated it then “P(i,j)” is not defined. In an instance in which ratings are implicitly derived, e.g., based on user interactions such as clicking, viewing or purchasing items, “P(i,j)” is set to one when the user interacted with the item or otherwise zero when the user has not interacted with the item.

The matrix factorization approach to generate recommendations factorizes the matrix “P” into two matrices “U” and “I” which are a user latent factor matrix and an item latent factor matrix, respectively. The matrix “U” is of order “n×k” and “I” is of order “m×k” where “m” represents a number of users and “n” refers to a number of items. The variable “k” represents the number of latent factors that is specified as part of matrix factorization. This means that each user and item is described by certain features. The term “latent” indicates that these features are not explicit, i.e. are hidden and not directly observable. To predict an unknown matrix entry “P(x,y),” a dot product is computed between “U(x)” and “I(y),” which is an operation that takes two equal length sequences of numbers (e.g., vectors) and returns a single number, which can be defined either algebraically or geometrically. Algebraically, it is the sum of the products of the corresponding entries of the two sequences of numbers, and geometrically it is the produce of the Euclidean magnitudes of the two vectors and the cosine of the angle between them.

A variety of different techniques may be employed to perform matrix factorization, an example of which is referred to as alternating least squares (ALS). Performance of the alternating least squares technique involves minimizing a cost function that (excluding the regularization terms) is the sum of squares of differences between a known value of “P(x,y)” and a value computed using dot product between “U(x)” and “I(y).”

Starting with random factors “U” and “I,” this technique first computes “U” by keeping “I” fixed and then calculates “I” using the previously computed “U” and so on. After a few iterations, the factor matrices “U” and “I” converge. When one of “U” or “I” is fixed, then the cost function reduces to a quadratic (convex) function in “I” or “U” respectively, and the optimal solution for this step can be directly obtained. In this way, “U(x),” for each user “x,” can be calculated independently of latent factors of other users and the same is valid for computation of each “I(y),” when “U” is fixed. Thus, all user or item factor calculations may be performed in parallel, thus having increased computational efficiency.

additionally, recommendation control techniques are described that employ incremental matrix factorization and clustering, which may be used to support real time generation of recommendations in an accurate manner. The techniques described herein are used to re-compute a user latent factor (and not the complete user latent factor matrix “U”) that is specific to the user whose interaction with an item is to be factored in as part of making the recommendation. In this way, the update of the latent factor for a single user is not computationally expensive (as opposed to computation of the user latent factor matrix as a whole) and thus can be done in real-time or near real-time as further described in the following.

Additionally, techniques are described in the following to balance storage and computation requirements (e.g., at runtime) without a significant impact on the quality of the recommendations. For example, clustering techniques may be used to find recommendations for “K” representative user-latent-factors, e.g., through use of K-means clustering on the “U” vectors. This may be used to conserve storage and pre-computation resources because recommendations are not computed and stored for each of the users.

Further, by precomputing a number of recommendations that is larger than the number returned for each user may be used to find the “right set” of recommendations for the user that are associated with the cluster. As described in the following in greater detail, based on an experimental dataset, resource consumption involving the generation of the top-50 recommendations is not significantly impacted when pre-computing and storing 250 recommendations for each representative user-latent-factor.

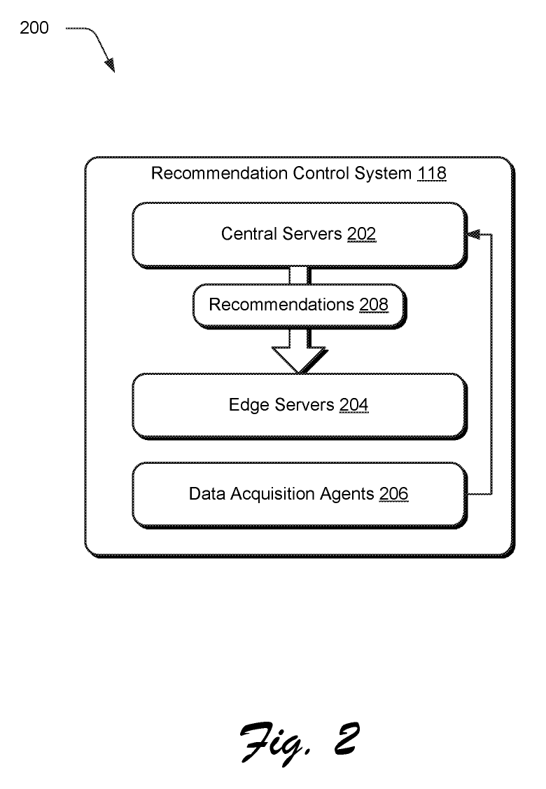

FIG. 2 depicts an example embodiment 200 showing the recommendation control system 118 of FIG. 1 in greater detail. The recommendation control system 118 in this example includes logical entities that may be implemented by one or more computing devices as further described in relation to FIG. 9. Example of these logical entities include central servers 202, edge servers 204, and data acquisition agents 206.

Central Servers 202 are representative of functionality to perform batch processing (e.g., asynchronously) to support runtime requests. For example, the central servers 202 may be configured to implement alternating least squares techniques to find user and item latent factor matrices, perform K-means clustering to determine K representative user-latent-factors and assign each user latent factor to one of the clusters. Additionally, the central servers 202 may compute “N*L” recommendations 208 for each of “K” representative user latent factor, where “N” is the number of top recommendations used in a request at run time and “L” is a small integer (e.g. 10) that is also sufficiently large so that the quality of recommendations is not impacted later. Data acquisition agents 206 are representative of functionality to supply user/item interaction data to the central servers 206.

Edge servers 204 are representative of functionality to cache the information computed by the central servers 204 that is used to form the recommendations 208. The edge servers 204 handle requests for fetching top-N recommendations for users at run time. The edge servers 204 may also be configured to compute the user latent factor based on recent user-item interactions in real time. Alternatively this can be computed at the central servers 202 and pushed to edge servers 204 and get requests to obtain the recommendations 208 as the edge servers continue use of previous user latent factors until an update is pushed.

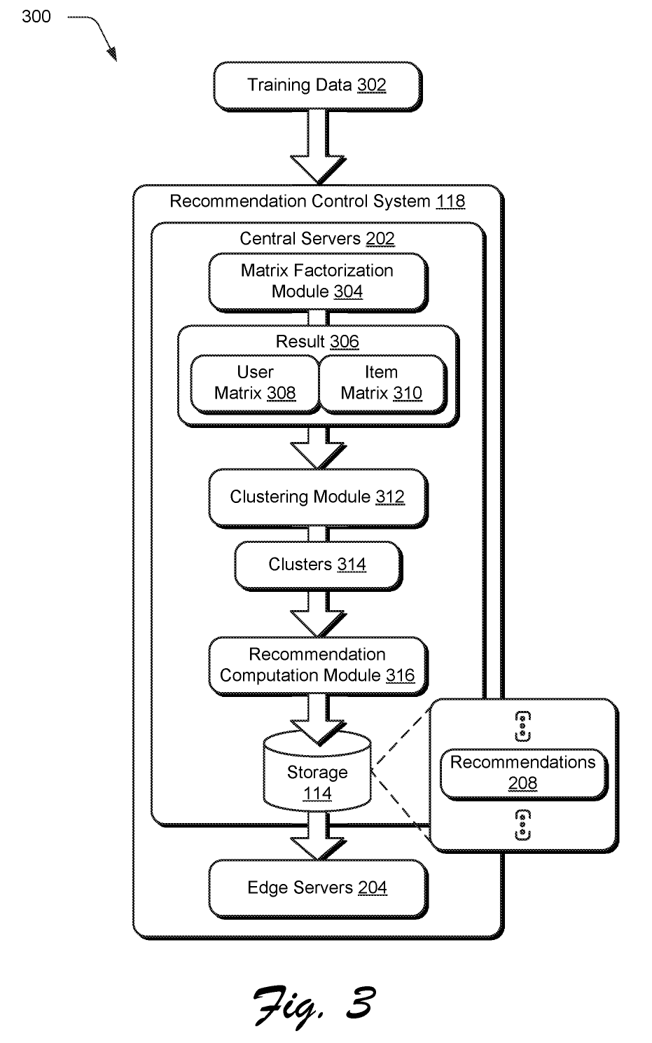

FIG. 3 depicts an example embodiment 300 in which central servers 202 of the recommendation control system 118 are used to compute recommendations 208. First, the central servers 202 obtain training data 302 to train a model, such as data that describes user interactions with digital content, how the interaction occurred, from where the interaction occurred, what devices were used to perform the interaction, and so on. A data acquisition agent 206, for instance, may monitor user interaction with a service provider 102 (e.g., with a web site provided by the service provider 102) and provide data that describes this interaction as training data 302 to the central servers.

Training of a model begins with a matrix factorization module 304 that is configured to process the training data 302 as a batch at predefined intervals of time, e.g., daily. The matrix factorization module 304 employs matrix factorization using alternating least squares (ALS) to compute a result 306 that includes latent factors for users and items (i.e., user matrix 308 “U” and item matric 310 “I”) based on a ratings matrix “P.” Depending on the application domain, the ratings matrix “P” may contain all ratings provided explicitly by users for items, or it could be derived implicitly based on how each user interacts with items. In each ALS iteration, alternately one of “U” or “I” is kept fixed and other one is recomputed. This is repeated by the matrix factorization module 304 until convergence, e.g., until no more significant improvements in a cost function of the ALS technique is observed.

The result is then provided to a clustering module 312. The clustering module 312 is representative of functionality to compute “K” (e.g., 1000) representative user latent vectors, e.g., by performing K-means clustering. A hash table is then computed by the clustering module 312 that maps each user to a corresponding cluster identifier for later lookup as described in the following.

A recommendation computation module 316 is then employed by the recommendation control system 118 to pre-compute recommendations 208, illustrated as stored in storage 114, for each “K” latent factor. For example, the recommendation computation module 316 may perform the following for each “K” latent factor from the clusters 314. First, a dot product is computed for the item latent factors from the item matrix to form matrix “V”. A subset of the highest dot-products results are then stored in storage 114 for each cluster (e.g., N*10 such as 1000 items) as recommendations 208. The recommendations 208 are then pushed to the edge servers 204 to be used at run time as further described in the following.

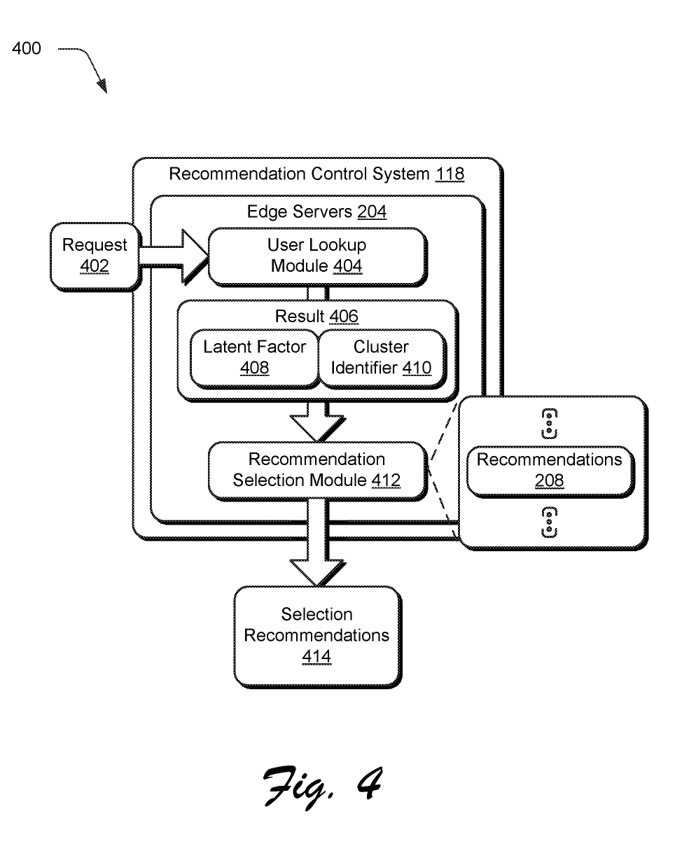

FIG. 4 depicts an example embodiment 400 in which recommendations 208 formed by the central servers 202 in FIG. 3 are employed at runtime by one or more edge servers 204 to select recommendations to control digital content interaction with a user. The edge servers 204, as previously described, are configured to respond to requests to provide recommendations 208 at runtime to control user interaction with digital content.

The edge servers 204, for instance, may receive a request 402, such as a “GET_TopN_recommendations(N, user-id u)” request in real time. The request includes a user identifier and specifies a number of recommendations to be provided in this example. A user lookup module 404 is employed that is representative of functionality to generate a result 406 that includes the latest latent factor “u” 408 and a cluster identifier 410 for the user identifier in the request 402 in the lookup table created as described in relation to FIG. 3.

For each item latent factor “I” in the list of recommended products or services for this cluster identifier 410, a dot product is computed by a recommendation selection module 412 of latent factors of item “I” and user “u”. The recommendation selection module 412 then selects the “N” highest dot products and returns those items as recommendations 208. In this way, the edge servers 204 may provide recommendations in real time as users navigate through a website to control which digital content is exposed to those users during the navigation.

Return will now be made to FIG. 2. Data acquisition agents 206 provide data to the central servers 202 that describes user/item interactions that occur with digital content of the service provider 102. The central servers 202 compute the latent factor for that specific user, solely, and push the update to the edge servers 204. This computation is the same as the ALS iteration where “I” (item latent factor matrix) is kept fixed and used to compute “U.” Instead of calculating the entirety of “U” (i.e., all user latent factors in parallel), here a single latent factor is recomputed for the current user, thereby causing an update to the ratings-matrix “P” to be factored in.

When repeating the batch processing performed by the central servers 202, the last updated values of latent factor vectors (U, I) may be reused as the initial values, instead of starting with random values. Similar optimization is applicable for clustering, in which the clustering may be performed by starting with the last computed centroids (cluster-means) instead of random centroids. In this way, faster convergence may be achieved for both steps in the subsequent computations performed as part of the batch processing, thus conserving computational resources with improved efficiency.

Accordingly, the two challenges mentioned above are addressed using different techniques. Again, item and user factor matrices are first set to random values in conventional use of alternating least squares. The item or the user matrix is kept constant and the other one of the item or user matrix is computed. This process is then reversed and repeated until convergence.

In the techniques described herein, an alteration is made to this ALS technique such that previous values of user and item factor matrices are kept rather than with random values. Then, the item factor matrix is kept constant and the user factor matrix is recomputed. This technique then terminates. In this way, the user factors are updated and the item factors remain unchanged and thus addresses real life usage in which users' tastes change more frequently than attributes of items or services made available by the service provider 102. Hence, the item factors are not recomputed on each interaction since the item factors are less likely to change, thereby conserving valuable computational resources and supporting real time performing.

FIG. 5 depicts a table 500 in an example embodiment showing variation in an error function with percentage of data used for training. In this example, a dataset is used that has one million ratings for six thousand users and four thousand items, e.g., movies. The data is split into 60% training, 20% validation and 20% test. The validation set is used to tune hyper parameters of the model. It was found in this example that the best results are obtained for rank=10, lambda=0.05, number of iterations=25 and alpha=0.005.

In order to test the incremental ALS technique, part of the training data was used to train ALS and the remaining part of the training data was used to update ALS. An error measure is then calculated using a Root Mean Squared Error (RMSE) technique. This is computed by computing the squared difference between predicted and actual ratings, which is then summed over. The mean of this value is then computed followed by the square root to obtain the RMSE value.

As is apparent from the table 500, an RMSE value of 0.856 is obtained when the entire training dataset is used to train. If eighty percent of the training data is used, then an initial RMSE of 0.883 is obtained. When updating the model with the remaining twenty percent of the training data the RMSE value falls to 0.875. As the proportion of training data is reduced this effect becomes more pronounced.

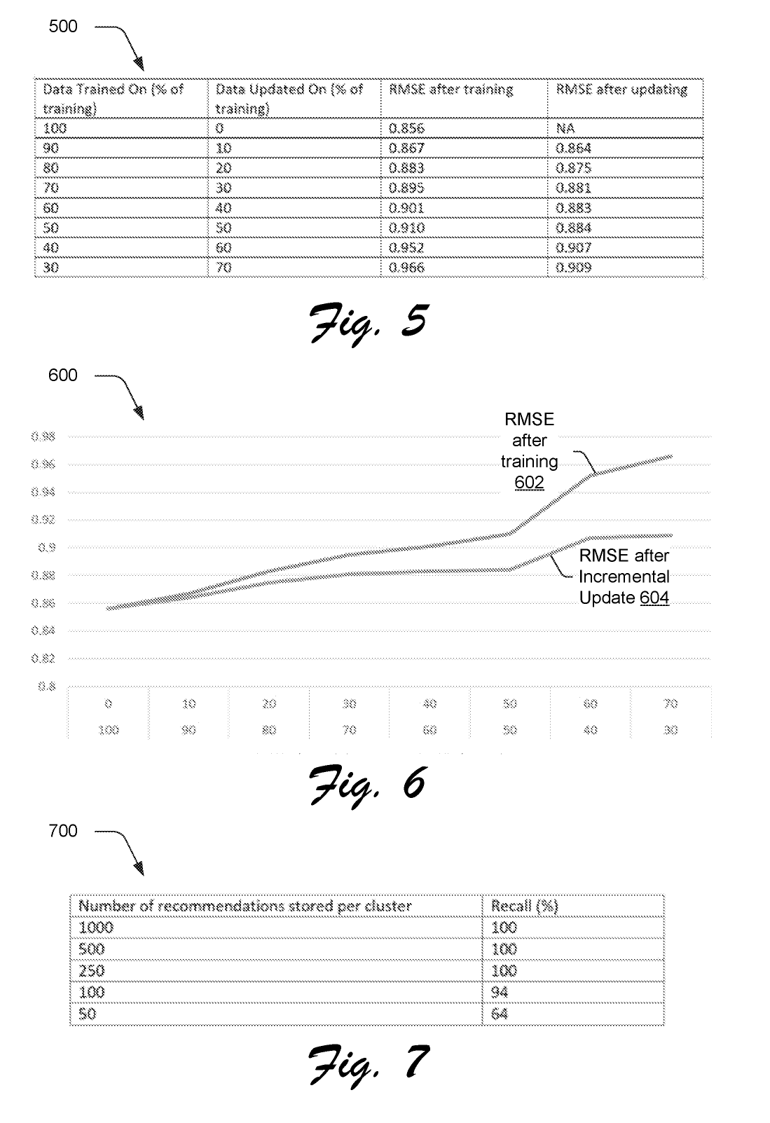

As shown in a graph 600 of FIG. 6 in which RMSE after training 602 and before training 604 is shown, as the amount of data used to train is reduced, the RMSE increases. Further, for low percentage of training data (such as forty percent training and sixty percent updating data) the single step update provides greater improvement in the RMSE score than for correspondingly higher percentages of training data.

As can be observed the results of the techniques described herein, this approach combines both the features to solve the challenge of providing real time recommendations in a computationally and storage efficient manner. For example, since a single step of the ALS technique may be used, these techniques are computationally far less expensive than performing ALS on the updated dataset. Also, accuracy of these techniques are similar as shown in the table 500 and graph 600 and thus these recommendations are considered to be of high quality due to the accuracy demonstrated.

The output of the ALS technique provides a set of user as well as item factors such that each user can be represented by a point in a k-dimensional factor space. Accordingly, clustering may then be performed using this factor space in order to identify similar users, i.e., have similar latent factors. In other words, similar users behave in a similar manner when interacting with digital content of the server provider 102, e.g., a website. A list of recommendations for items or services are then calculated for each centroid. Thus, when a subsequent user visits the website, a determination is first made as to which cluster corresponds to the subsequent user. A list of recommendations (e.g., recommended items or services) for that cluster centroid is then obtained. Finally, a dot product of the user's factors and each item in the list is computed and the list is reordered for the particular user. The top “N” items in that list are then chosen, which serve as a basis to provide user specific recommendations to control subsequent user interaction with digital content of the service provider 102.

These techniques may also support a tradeoff between storing recommendations per user versus computation of a dot product for each item. For example, a predefined number (e.g., one thousand clusters) may be maintained for the user data. This predefined number may be determined based on cross validation beforehand Clustering is then precomputed using an approach such as K-Means. K-Means has the further advantage of being incremental, and as such, users may be added without repeating performance of each of the steps. Therefore, one thousand recommendations may be stored per cluster centroid, which provides a margin of safety to support filtering, e.g., to remove items already purchased by the user. Thus, this involves storage of 1000×10×STR space (storage space required) and further 1000×TME time (time for computing one dot product between a given user latent factor and an item latent factor) is spent for computing dot products, thus conserving both computational and storage resources.

These techniques are further scalable in both the number of users as well as the number of items. For example, as the number of users increase, the users may be assigned to existing clusters. Periodic updates may be performed to re-cluster the data in its entirety to form new clusters to address global user changes. Thus, even as the number of users increase, the storage cost is still defined by the number of clusters, rather than the number of users.

As the numbers of items in the catalog increase, these techniques still consume an amount of resources that are used to compute a number of recommendations per cluster, instead of being based on a number of items. Hence, the techniques described herein scale both with number of users as well as number of items (e.g., goods or services) offered by the service provider 102.

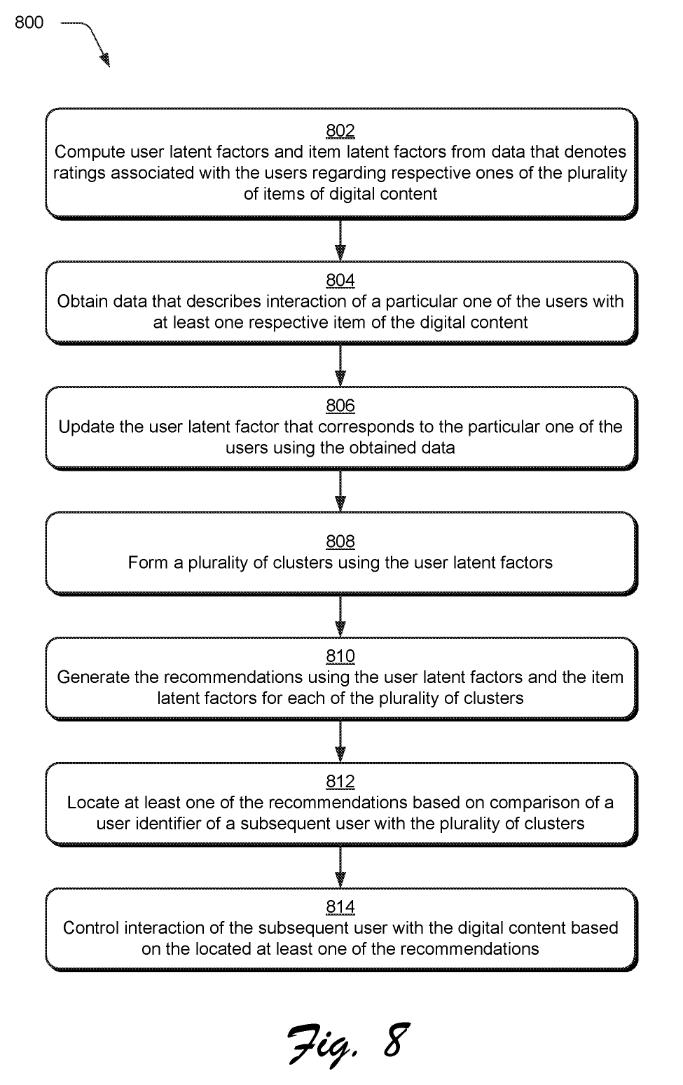

FIG. 7 depicts a table 700 that shows examples of results obtained using clustering. In this example, recall is used as a measure to judge how well the technique performs. For instance, by one hundred percent recall it is meant that each item in the top fifty items recommended for the user appears in the top “N” items recommended for a corresponding cluster centroid. The number of clusters used in K-Means is taken as five hundred in this example. As may be observed from the table 700, even when a value of “N” as 250 is used, recall stays at one hundred percent. What this means is that if 250 recommendations are stored per cluster and these recommendations are reordered for each user, the results would be same as if a dot product is computed with each item. Also, as the number of recommendations stored per cluster decreases, the observed recall decreases.

Using the techniques described herein, recommendations are precomputed per cluster and a determination is then made to which cluster the subsequent user “U” belongs. Only the recommendations for that cluster are reordered and returned to the user, which thus also conserves computational and storage resources. Observations described above show that such an approach is capable of delivering the relevant recommendations with high recall and in a fraction of the time as compared to existing approaches.

Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-7.

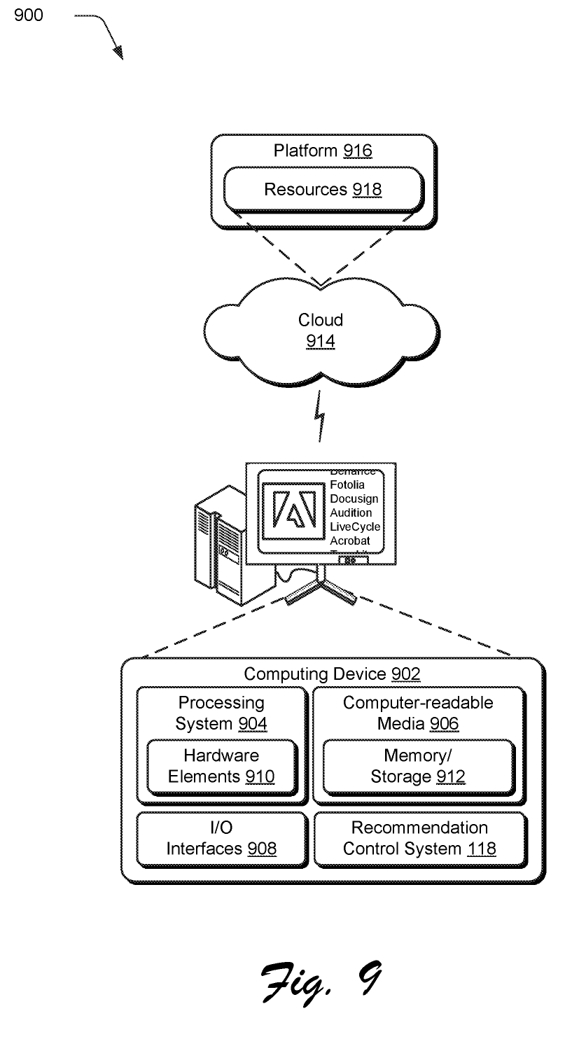

FIG. 8 depicts a procedure 800 in an example embodiment in which recommendation control employs incremental matrix factorization and clustering. User latent factors and item latent factors are computed from data that denotes ratings associated with the users regarding respective ones of the plurality of items of digital content (block 802). For example, the user latent factors may be defined using a user latent factor matrix, the item latent factors defined using an item latent factor matrix, and the data that denotes ratings associated with the users regarding respective ones of the plurality of items defined by a user-item matrix. The ratings associated with the user regarding the respective ones of the plurality of items is obtained explicitly from the user for the items or is derived implicitly based on how each of the user interacts with the respective ones of the plurality of items.

The user latent factor matrix and the item latent factor matrix are calculated using a matrix factorization technique from the user-item matrix, such as an alternating least squares technique. This may be performed using a plurality of iterations is which one of the user latent factor matrix or the item latent factor matrix is kept fixed while the other one of the user latent factor matrix or the item latent factor matrix is recomputed until convergence.

Data is obtained that describes interaction of a particular one of the users with at least one respective item of the digital content (block 804). For example, this data may describe a user's current interaction with a website or other digital content of a service provider. The user latent factor is updated that corresponds to the particular one of the users using the obtained data (block 806), and not for an entirety of the user latent factor matrix and in this way supports real time performance in the calculation of recommendations.

A plurality of clusters is formed using the user latent factors (block 808), such as to group users of the user latent factor matrix based on similarity, one to another. A variety of clustering techniques may be used, such as a K-means clustering techniques.

The recommendations are generated using the user latent factors and the item latent factors for each of the plurality of clusters (block 810). In this way, a number of recommendations formed may be reduced, thus improving computational and storage efficiency. Further, at least one of recommendations is located based on comparison of a user identifier of a subsequent user with the plurality of clusters (block 812), which is previously described does not have a significant impact on accuracy and yet is usable to support real time recommendations. Operations of blocks 810 and 812 may be performed offline. Interaction of the subsequent user with the digital content is controlled based on the located at least one of the recommendations (block 814), such as to determine which items of digital content are most likely to result in interaction or conversion by the subsequent user, and thus is beneficial to both the subsequent user as well as the service provider. A variety of other examples are also contemplated as described above, such as for other forms of digital content such as emails, electronic messages, and so forth.

Example System and Device

FIG. 9 illustrates an example system generally at 900 that includes an example computing device 902 that is representative of one or more computing systems or devices that may implement the various techniques described herein. This is illustrated through inclusion of the recommendation control system 118. The computing device 902 may be, for example, a server of a service provider, a device associated with a client (e.g., a client device), an on-chip system, or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include embodiment in hardware as an application specific integrated circuit or other logic device formed using one or more semiconductors. The hardware elements 910 are not limited by the materials from which they are formed or the processing mechanisms employed therein. For example, processors may be comprised of semiconductor(s) or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An embodiment of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media or devices that enable persistent or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other embodiments in silicon or other hardware. In this context, hardware may operate as a processing device that performs program tasks defined by instructions or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions or logic embodied on some form of computer-readable storage media or by one or more hardware elements 910. The computing device 902 may be configured to implement particular instructions or functions corresponding to the software or hardware modules. Accordingly, embodiment of a module that is executable by the computing device 902 as software may be achieved at least partially in hardware, e.g., through use of computer-readable storage media or hardware elements 910 of the processing system 904. The instructions or functions may be executable/operable by one or more articles of manufacture (for example, one or more computing devices 902 or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes or is representative of a platform 916 for resources 918. The platform 916 abstracts underlying functionality of hardware (e.g., servers) and software resources of the cloud 914. The resources 918 may include applications or data that can be utilized while computer processing is executed on servers that are remote from the computing device 902. Resources 918 can also include services provided over the Internet or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, embodiment of functionality described herein may be distributed throughout the system 900. For example, the functionality may be implemented in part on the computing device 902 as well as via the platform 916 that abstracts the functionality of the cloud 914.

### CONCLUSION

Although the invention has been described in language specific to structural features or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to generate recommendations to control user interaction with digital content, a method implemented by at least one computing device comprising:
computing user latent factors and item latent factors by the at least one computing device from data that denotes ratings associated with the users regarding respective ones of the plurality of items of digital content;
obtaining data by the at least one computing device that describes interaction of a particular one of the users with at least one respective item of the digital content;
updating the user latent factor that corresponds to the particular one of the users using the obtained data by the at least one computing device; and
generating at least one of the recommendations by the computing device using the updated user latent factors, the recommendation configured to control subsequent interaction of the particular user with digital content of the service provider.

2. The method as described in claim 1, wherein the user latent factors are defined using a user latent factor matrix, the item latent factors are defined using an item latent factor matrix, and the data that denotes ratings associated with the users regarding respective ones of the plurality of items is defined by a user-item matrix.

3. The method as described in claim 2, wherein the updating is performed solely for the user latent factor that corresponds to the particular one of the users and not other parts of the user latent factor matrix.

4. The method as described in claim 2, wherein the user latent factor matrix and the item latent factor matrix are calculated using a matrix factorization technique from the user-item matrix.

5. The method as described in claim 4, wherein the matrix factorization technique is performed using a plurality of iterations is which one of the user latent factor matrix or the item latent factor matrix is kept fixed while the other one of the user latent factor matrix or the item latent factor matrix is recomputed until convergence.

6. The method as described in claim 4, wherein the matrix factorization technique includes an alternating least squares technique.

7. The method as described in claim 1, wherein the rating associated with the user regarding the respective ones of the plurality of items is obtained explicitly from the user for the items or is derived implicitly based on how each of the users interacts with the respective ones of the plurality of items.

8. The method as described in claim 1, further comprising repeating the computing beginning with the user latent factors and the item latent factors to form subsequent user latent factors and item latent factors.

9. The method as described in claim 1, further comprising clustering the user latent factors into a plurality of clusters, generating recommendations for each of the plurality of clusters, receiving a user identifier of the subsequent user, determining which of the plurality of clusters correspond to the subsequent user based on the user identifier, and locating at least one of the generated recommendations to control interaction of the subsequent user with the digital content of the service provider.

10. In a digital medium environment to generate recommendations to control user interaction with digital content, a method implemented by at least one computing device comprising:
computing user latent factors and item latent factors by the at least one computing device from data that denotes ratings associated with the users regarding respective ones of the plurality of items of digital content;
forming a plurality of clusters using the user latent factors by the at least one computing device; and
generating the recommendations by the at least one computing device using the user latent factors and the item latent factors for each of the plurality of clusters, the recommendations located based on correspondence of subsequent users with respective ones of the clusters to locate corresponding recommendations to control subsequent interaction of the users with digital content of the service provider.

11. The method as described in claim 10, wherein the clustering is performed by the at least one computing device using a K-means clustering technique.

12. The method as described in claim 10, further comprising:
obtaining data by the at least one computing device that describes interaction of a particular one of the users with at least one respective item of the digital content; and
updating the user latent factor that corresponds to the particular one of the users using the obtained data by the at least one computing device.

13. The method as described in claim 10, wherein the user latent factors are defined using a user latent factor matrix, the item latent factors are defined using an item latent factor matrix, and the data that denotes ratings associated with the users regarding respective ones of the plurality of items is defined by a user-item matrix.

14. The method as described in claim 13, wherein the user latent factor matrix and the item latent factor matrix are calculated using a matrix factorization technique from the user-item matrix.

15. The method as described in claim 14, wherein the matrix factorization technique is performed using a plurality of iterations is which one of the user latent factor matrix or the item latent factor matrix is kept fixed while the other one of the user latent factor matrix or the item latent factor matrix is recomputed until convergence.

16. The method as described in claim 14, wherein the matrix factorization technique includes an alternating least squares technique.

17. In a digital medium environment to control user interaction with digital content based on recommendations, a system implemented by at least one computing device to perform operations comprising:
computing user latent factors and item latent factors from data that denotes ratings associated with the users regarding respective ones of the plurality of items of digital content;
obtaining data that describes interaction of a particular one of the users with at least one respective item of the digital content;
updating the user latent factor that corresponds to the particular one of the users using the obtained data;
forming a plurality of clusters using the user latent factors;
generating the recommendations using the user latent factors and the item latent factors for each of the plurality of clusters;
locating at least one of recommendations based on comparison of a user identifier of a subsequent user with the plurality of clusters; and
controlling interaction of the subsequent user with the digital content based on the located at least one of the recommendations.

18. The system as described in claim 17, wherein the forming is performed such that similar users are included in a same said cluster.

19. The system as described in claim 17, wherein the generating includes precomputing the recommendations for a centroid of each said cluster such that a number of the recommendations precomputed for each said cluster is greater than a number of the recommendations used as part of the locating.

20. The system as described in claim 19, wherein the locating is performed based at least in part on a dot product of a user latent factor of the subsequent user and the item latent factors for items in the precomputed set of recommendations for a corresponding said cluster.
